(19) United States
(12) Patent Application Publication
(10) Pub. No.: US 2020/0269466 A1
(43) Pub. Date: Aug. 27, 2020

(54) APPARATUS FOR EXTRUDING HONEYCOMB BODIES, METHODS OF ASSEMBLING APPARATUS, AND METHODS OF MANUFACTURING HONEYCOMB BODIES

(71) Applicant: CORNING INCORPORATED, Corning, NY (US)

(72) Inventors: Jan HODEL, Kaiserslautern (DE); Viktor KAMMERER, Kaiserslautern (DE); Helmut Roland LETZEL, Herschweller-Pettersheim (DE)

(73) Assignee: Corning Incorporated, Corning, NY (US)

(21) Appl. No.: 15/776,282

(22) PCT Filed: Nov. 18, 2016
(86) PCT No.: PCT/US2016/062684

§ 371 Date: May 15, 2018

Related U.S. Application Data
(60) Provisional application No. 62/258,148, filed on Nov. 20, 2015.

(51) Int. Cl. B28B 3/26; B28B 3/20; B28B 17/00

(52) U.S. Cl. CPC B28B 3/2672; B28B 3/20; B28B 2003/203; B28B 17/0081; B28B 17/009; B28B 3/269

(57) ABSTRACT

An extrusion apparatus (200) and method to extrude ceramic precursor batch through a die to form a honeycomb extrudate (100), and an apparatus assembly method, are provided. The apparatus comprises a tail ring device (202) comprising a tapered inner opening configured to funnel the batch downstream from upstream extrusion hardware, wherein an inner surface (318,320) of the tail ring device (202) comprises no pockets or protrusions to disrupt batch flow; a bow control device (204) disposed on the tail ring device (202) comprising an aperture (414) defined by shutter plates (S1-S4) to control a bow of the honeycomb body extrudate (100) formed from the batch flowing through the die by adjustment of the shutters (S1-S4); and an edge flow control device (206) disposed on the bow control device (204) comprising edge plates (816) configured to protrude into the batch to control an edge flow of the batch flowing to a periphery of the die.

### CROSS-REFERENCE TO RELATED APPLICATIONS

This application claims the benefit of priority of U.S. Provisional Application Ser. No. 62/258,148 filed on Nov. 20, 2015 the content of which is relied upon and incorporated herein by reference in its entirety.

### BACKGROUND

### Field

Exemplary embodiments of the present disclosure relate to apparatus for extruding honeycomb bodies, methods of assembling apparatus to extrude honeycomb bodies, and methods of manufacturing honeycomb bodies.

### Discussion of the Background

Honeycomb bodies may be used in a variety of applications such as fluid cleaning or separation. After-treatment of exhaust gas from internal combustion engines may use catalysts supported on high-surface area substrates and, in the case of diesel engines and some gasoline direct injection engines, a filter or catalyzed filter for the removal of particulates. Filters and catalyst supports in these applications may be refractory, thermal shock resistant, stable under a range of pO₂ conditions, non-reactive with the catalyst system, and offer low resistance to exhaust gas flow. Porous ceramic flow-through honeycomb substrates and wall-flow honeycomb filters may be used in these applications.

The manufacture of ceramic honeycomb structures may be accomplished by the process of plasticizing ceramic powder batch mixtures, extruding the mixtures through honeycomb extrusion dies to form honeycomb extrudate, and cutting, drying, and firing the extrudate to produce ceramic honeycombs of high strength and thermal durability. The ceramic honeycombs thus produced are widely used as ceramic catalyst supports in motor vehicle exhaust systems, and as catalyst supports and wall-flow particulate filters for the removal of soot and other particulates from diesel engine exhausts.

Among the commercially successful processes for ceramic honeycomb manufacture are those that utilize large co-rotating twin screw extruders for the mixing and extruding of ceramic honeycomb extrudate. Single screw extruders may also be used. Ram extrusion, pressing, casting, spraying and 3-dimensional printing are other processes for ceramic honeycomb manufacture.

The above information disclosed in this Background section is only for enhancement of understanding of the background of the disclosure and therefore it may contain information that does not form any part of the prior art nor what the prior art may suggest to a person of ordinary skill in the art.

### SUMMARY

Exemplary embodiments of the present disclosure provide an apparatus for extruding honeycomb bodies.

Exemplary embodiments of the present disclosure also provide a method of assembling an apparatus for manufacturing honeycomb bodies.

Exemplary embodiments of the present disclosure also provide a method of manufacturing honeycomb bodies.

Additional features of the disclosure will be set forth in the description which follows, and in part will be apparent from the description, or may be learned by practice of the disclosure.

An exemplary embodiment discloses an extrusion apparatus to extrude plasticized ceramic precursor batch through a die to form a honeycomb body extrudate. The apparatus comprises a tail ring device comprising a tapered inner opening configured to funnel the batch downstream from upstream extrusion hardware. The apparatus comprises a bow control device disposed on the tail ring device and the bow control device comprises an inner batch flow opening and an aperture defined by shutter plates, the bow control device is configured to receive the batch from the tail ring and configured to control a bow of the honeycomb body extrudate. The apparatus also comprises an edge control device disposed on the bow control device, and the edge flow control device comprises a batch flow opening to receive the batch from the bow control device and edge plates configured to protrude into the batch to control an edge flow of the batch flowing to a periphery of the die.

Another exemplary embodiment discloses a method of assembling an apparatus to extrude a honeycomb body in an axial direction. The method comprises attaching a die to an edge control device, a bow control device and a tail ring to form an assembly, and attaching a change-over ring to the tail ring device. The tail ring device comprises a tapered inner opening configured to funnel batch downstream from upstream extrusion hardware. The change-over ring comprises a pocket defined by a radial protrusion configured to engage a grip tool. The method further comprises engaging the change-over ring with a grip tool and sliding the grip tool and tail ring device attached to the assembly into a cartridge at a front end of an extruder. The method further comprises disengaging the grip tool from the change-over ring, and removing the change-over ring from the tail ring device.

Another exemplary embodiment discloses a method of manufacturing a honeycomb extrudate. The method includes providing a pressure to a plasticized batch upstream of a tail ring device, funneling the batch through an opening defined by a tapered inner diameter of the tail ring device, flowing the batch through an aperture of a bow control device downstream of the tail ring device, controlling a bow of a honeycomb extrudate by adjusting the aperture; flowing the batch through an opening of an edge flow control device downstream of the bow control device and controlling a peripheral feed of the batch upstream of a honeycomb extrusion die by adjusting an edge plate position, extruding the batch through the die to form the honeycomb extrudate. The funneling in the method comprises no dead zones for batch flow along the tapered inner diameter.

It is to be understood that both the foregoing general description and the following detailed description are exemplary and explanatory and are intended to provide further explanation of the disclosure.

### BRIEF DESCRIPTION OF THE FIGURES

The accompanying drawings, which are included to provide a further understanding of the disclosure and are incorporated in and constitute a part of this specification, illustrate exemplary embodiments of the disclosure, and together with the description serve to explain the principles of the disclosure.

FIG. 1 illustrates a schematic extruded honeycomb body having matrix and skin extruded simultaneously from the same batch material through a die providing an extrude-to-shape honeycomb body according to exemplary embodiments of the disclosure.

FIG. 2 presents an exploded perspective view of a honeycomb extrusion apparatus according to exemplary embodiments of the disclosure.

FIG. 3 shows a schematic cross section view perpendicular to a longitudinal axis of a honeycomb extrudate and perspective view of a tail ring device of the honeycomb extrusion apparatus in FIG. 2 according to exemplary embodiments of the disclosure.

FIG. 4A is a perspective view of a bow control device of the honeycomb extrusion apparatus in FIG. 2 according to exemplary embodiments of the disclosure. FIG. 4B is a perspective view of the bow control device of FIG. 4A with the cover plate removed and FIG. 4C is a cross section view of the bow control device of FIG. 4A according to exemplary embodiments of the disclosure. FIG. 4D is a detailed view of a shutter plate of the bow control device of FIG. 4A according to exemplary embodiments of the disclosure.

FIG. 5 is perspective view of the base ring of the bow control device of FIG. 4A according to exemplary embodiments of the disclosure.

FIG. 6 is a perspective view of upstream and downstream surfaces of the cover plate of the bow control device of FIG. 4A according to exemplary embodiments of the disclosure.

FIG. 7 is a cross section detail view of the bow control device of FIG. 4A according to exemplary embodiments of the disclosure.

FIG. 8A is a perspective view of an edge control device of the honeycomb extrusion apparatus in FIG. 2 according to exemplary embodiments of the disclosure. FIG. 8B is a perspective view of the edge control device of FIG. 8A with the cover plate removed and FIG. 8C is a cross section view of the edge control device of FIG. 8A according to exemplary embodiments of the disclosure.

FIG. 9 is perspective view of the support ring of the edge flow control device of FIG. 8A according to exemplary embodiments of the disclosure.

FIG. 10 is a cross section detail view of the edge flow control device of FIG. 8A according to exemplary embodiments of the disclosure.

FIG. 11 is a partial perspective and cross section detail view of the edge flow control device of FIG. 8A with a edge plate removed according to exemplary embodiments of the disclosure.

FIG. 12 shows a perspective view and a side view of an extruder front end assembly and a cartridge that houses and supports hardware devices to control extrusion processes at an extruder front end according to exemplary embodiments of the disclosure.

FIG. 13A is a perspective view of a change-over ring configured to attach to the tail ring device of the honeycomb extrusion apparatus in FIG. 2 according to exemplary embodiments of the disclosure. FIG. 13B is a perspective view of a grip tool configured to slide into the opening of the change-over ring attached to the tail ring device and FIG. 13C is a perspective view of the grip tool configured to engage the change-over ring attached to the tail ring device according to exemplary embodiments of the disclosure.

FIG. 14 is a schematic diagram illustrating a method of removing the honeycomb extrusion apparatus in FIG. 2 from a cartridge according to exemplary embodiments of the disclosure.

### DETAILED DESCRIPTION

It will be understood that for the purposes of this disclosure, “at least one of X, Y, and Z” can be construed as X only, Y only, Z only, or any combination of two or more items X, Y, and Z (e.g., XYZ, XYY, YZ, ZZ).

As used herein, “extrudate” refers to batch extruded through a die to form axially extending intersecting walls with channels there between. The channels can have cross sections of uniform or varying hydraulic diameter of various shapes, such as rectangular (square), hexagonal, other polygonal, circular, elliptical, other curved shapes, and the like, and combinations thereof. Extrusion can be by a continuous process such as a screw extruder, a twin-screw extruder, and the like, or by a discontinuous process such as a ram extruder and the like. In an extruder, an extrusion die can be coupled with respect to a discharge port of an extruder barrel, such as at an end of the barrel. The extrusion die can be preceded by other structure, such as a generally open cavity, screen/homogenizer, or the like to facilitate the formation of a steady plug-type flow front before the batch reaches the extrusion die.

The extrudate generally has a co-extruded, integrally formed, outer peripheral surface (skin) that extends in the axial direction. The extrudate outer periphery referred to herein as the extrudate contour can have various cross sectional shapes such as circular, elliptical, polygonal, etc., and combinations thereof, either symmetrical or asymmetrical. The plasticized batch can comprise inorganic powders, inorganic binders, organic binders, pore formers, solvents, non-solvents and the like. After the batch is extruded through the die to form the extrudate, it can be cut, dried, and fired to form a porous ceramic honeycomb body or porous ceramic honeycomb body segment.

Upon exiting the extruder in an axial direction, the batch stiffens into a wet extrudate comprising a network of axially extending intersecting walls (webs) that form axially extending channels and an axially extending outer peripheral surface. The webs and channels comprise the matrix. Disposed at the outer periphery of the matrix is the outer peripheral surface. The outer peripheral surface may be referred to herein as a co-extruded skin, an integrally formed co-extruded skin, or skin. A green ware honeycomb body or porous ceramic honeycomb body extruded with the skin on the matrix is referred to herein as an extrude-to-shape honeycomb body.

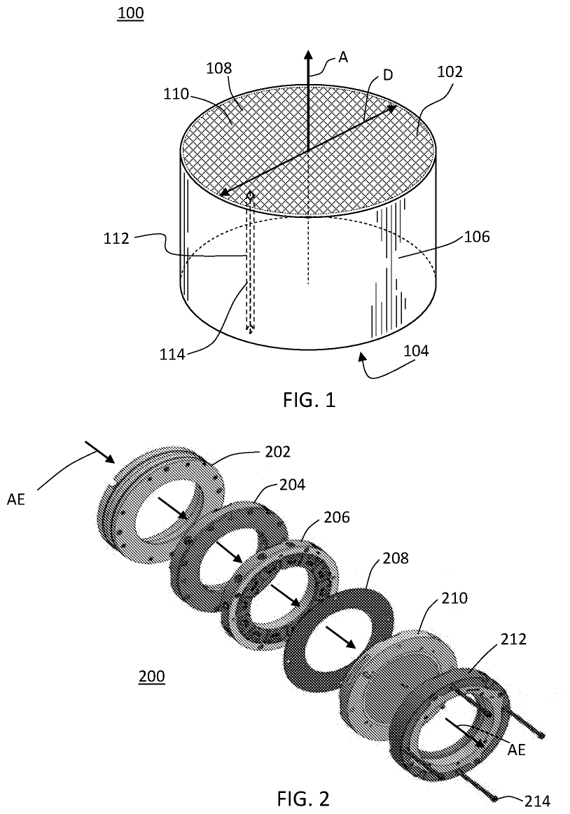

FIG. 1 is a schematic diagram of an extruded honeycomb body having matrix and skin extruded simultaneously from the same batch material through a die providing an extrude-to-shape honeycomb body according to exemplary embodiments of the disclosure. The honeycomb body 100 includes a first end face 102 and a second end face 104 having the skin 106 form the outer periphery of the honeycomb body extending from the first end face 102 to the second end face 104. A plurality of intersecting walls 108 that form mutually adjoining channels 110 extending in the axial direction “A” between opposing end faces 102, 104, according to exemplary embodiments of the disclosure, form the honeycomb matrix. Intersecting walls 112 forming a channel 114 extending between the end faces 102, 104 are shown for illustration. The axial direction is indicated by arrow “A” and a maximum cross sectional dimension perpendicular to the axial direction is indicated by “D”. For example, when the honeycomb body is a cylinder shape, the maximum dimension “D” may be a diameter of an end face. For example, when the honeycomb body cross section perpendicular to the axial direction is a rectangular shape, the maximum dimension “D” may be a diagonal of an end face.

FIG. 2 presents an exploded perspective view of a honeycomb extrusion apparatus according to exemplary embodiments of the disclosure. The extrusion apparatus 200 comprises hardware devices to control extrusion processes. A tail ring device 202 configured to accept batch flow from a twin screw, single screw, or ram extruder barrel (not shown here) can be disposed on an upstream surface of a bow control device 204. The bow control device 204 can be disposed on an upstream surface of an edge flow control device 206. The batch flow is indicated by arrows “AE” and enters the opening of the tail ring device 202 from the extruder barrel. The tail ring device 202 funnels the batch through adjustable apertures of the bow control device 204 and the edge flow control device 206 to input feedholes of a die in a die assembly 210. The die in the die assembly 210 is composed of peripheral feed holes and central feed holes communicating at one end with an inlet face, and at the other end with a plurality of interconnected peripheral discharge slots and central discharge slots, forming central pins and peripheral pins at an outlet (exit) face. An edge control device shim 208 may be disposed between the edge flow control device 206 and the die assembly 210. A skin forming device 212 may be disposed downstream of the die assembly 210 and the plasticized batch can flow through the skin forming device 212 after flowing through the die assembly 210 to form the extrude-to-shape honeycomb structure. The extrusion apparatus may be disposed in an extruder cartridge (not shown here) and the extruder barrel, extruder apparatus 200, and the extruder cartridge may be considered part of an extruder.

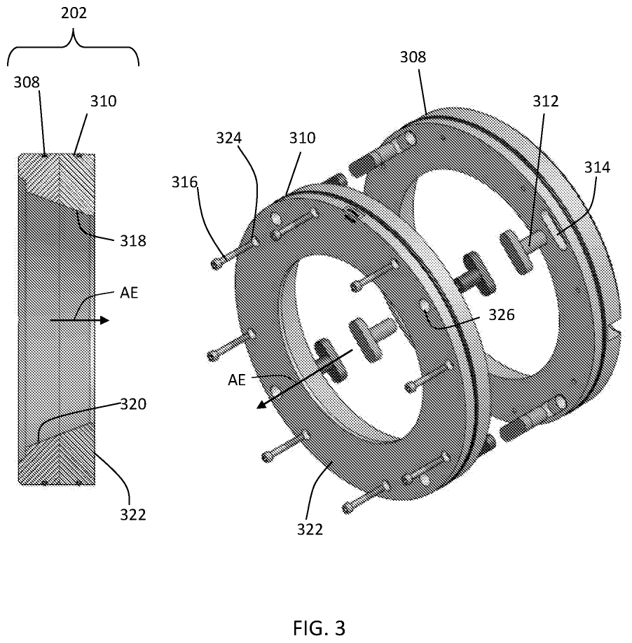

The tail ring device 202 provides multiple functions according to exemplary embodiments of the disclosure. For example, the tail ring device 202 can be an adapter between old hardware and new hardware when a new die assembly is coupled to an existing extruder barrel or, vice versa, when a new extruder barrel is coupled to an existing die assembly or batch control devices. For example, the tail ring device 202 can be an adapter existing expensive components such as rear spacers. The tail ring device 202 can comprise an ultra high molecular weight polymer, such as polyoxymethylene (POM) to reduce weight compared to a steel tail ring device. A steel tail ring device can exceed the weight limit for lifting the part by hand whereas the polymer tail ring device can be below the weight limit for lifting the part by hand. FIG. 3 shows a schematic longitudinal cross section view parallel to the longitudinal axis of the honeycomb extrudate direction “AE” and a perspective view of the tail ring device 202 of the honeycomb extrusion apparatus 200 in FIG. 2 according to exemplary embodiments of the disclosure.

The tail ring device 202 comprises an upstream part 308 and a downstream part 310, for example, to adapt between new and existing hardware. In order to withstand the forces and torques of screws, t-shaped inserts 312 with rounded corners comprising steel or similar material are disposed in grooves 314 in mating surfaces of the plastic parts 308, 310 to prevent the screws from being over tightened. The upstream part 308 comprises the grooves 314 in a downstream mating surface having the downstream part 310 disposed thereon and the downstream part 310 comprises the grooves 314 in an upstream mating surface having the upstream part 308 disposed thereon. T-shaped inserts 312 are disposed in the grooves 314 extending internally threaded cylinders through axial holes 326 in the respective tail ring device parts 308, 310. The parts 308, 310 can be held together by fasteners 316 through fastener holes 324, such that the upstream part 308 can accept screws in the internally threaded cylinders of the t-shaped inserts 312 to fasten upstream hardware such as a rear spacer of the extruder barrel and the downstream part 310 can accept screws in the internally threaded cylinders of the t-shaped inserts 312 to fasten a portion or the entire remaining extended range hardware of FIG. 2. Where the extended range hardware can include the bow control device 204, the edge flow control device 206, the edge control device shim 208, the die assembly 210, and the skin forming device 212. The forces from screws in the internally threaded cylinders of the t-shaped inserts 312 are accordingly spread out over an area of the mating surfaces in grooves 314.

An inner diameter of the upstream part 308 of the tail ring device 202 comprises a tapered surface 320 that defines a batch flow opening from a first upstream area to a first downstream area less than the first upstream area where area refers to the cross-sectional opening area perpendicular to the axial direction AE. An inner diameter of the downstream part 310 of the tail ring device 202 comprises a tapered surface 318 that defines a batch flow opening from a second upstream area to a second downstream area less than the second upstream area. The first downstream area and the second upstream area are substantially the same such that the tapered surfaces 318, 320 form a continuous tapered inner diameter surface. The continuous tapered inner diameter surface 318, 320 has no bumps or cavities that would disrupt a uniform flow of batch material through the opening from the first upstream area to the second downstream area. A bump or cavity can create a dead zone that can adversely impact batch rheology. The continuous tapered inner diameter surface 318, 320 funnels the flow of batch material from the first upstream area to the second downstream area smaller than the first upstream area with no dead zones for batch flow along the tapered inner diameter surface 318, 320 of the tail ring device 202.

The first and second upstream and the first and second downstream areas can be contour specific, that is, for example, circular, elliptical, race-track, or the like depending on the extrudate cross sectional shape transverse to the axial direction. The contour specific opening can protect downstream hardware against unnecessary axial pressure.

The tail ring device 202 comprises a transverse downstream surface 322 perpendicular (orthogonal) to the axial direction “AE” and surrounding the smaller area of the batch flow opening funnel to connect to an upstream surface of the bow control device 204.

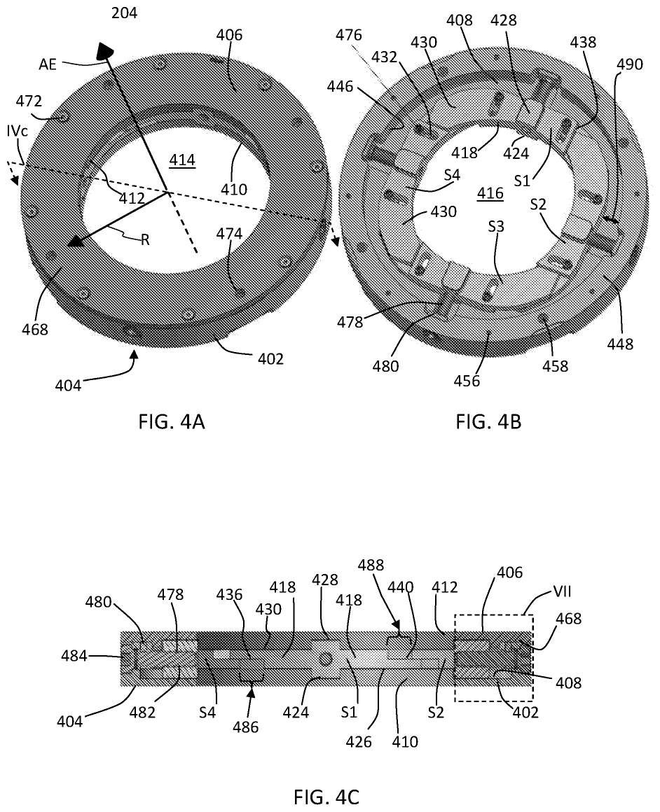

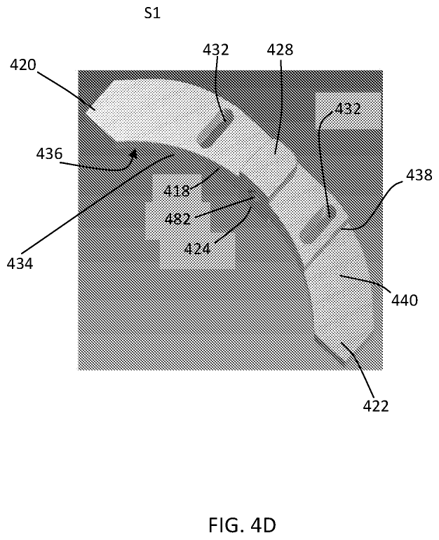

FIG. 4A is a perspective view of a bow control device of the honeycomb extrusion apparatus in FIG. 2 according to exemplary embodiments of the disclosure. FIG. 4B is a perspective view of the bow control device of FIG. 4A with the cover plate removed and FIG. 4C is a cross section view of the bow control device of FIG. 4A at IVc according to exemplary embodiments of the disclosure. The bow control device 204 comprises a base ring 402 having a transverse upstream surface 404 that can be disposed directly on the transverse downstream surface 322 of the tail ring device 202. The bow control device 204 comprises a cover ring plate 406 disposed on the base ring 402 opposite the upstream surface 404, and shutter plates S1, S2, S3, S4 disposed in a radial cavity 408 of the base ring 402 and the cover ring plate 406. The base ring 402 comprises an inner axial surface 410, which together with an inner axial surface 412 of the cover ring plate 406 defines a batch flow opening 414. The shutter plates S1, S2, S3, S4 can protrude radially into the batch flow opening 414 from the radial cavity 408 to form a bow control aperture 416.

As illustrated in FIG. 4B, the shutter plates S1, S2, S3, S4 can be the same as each other and interchangeable, greatly simplifying handling and machining over prior disclosed designs. FIG. 4D is a detailed view of a shutter plate of the bow control device of FIG. 4A according to exemplary embodiments of the disclosure. Shutter plate S1 will be described as representative of the shutter plates S1, S2, S3, S4. The shutter plate S1 comprises a generally arcuate shape having an inner surface 418 that forms a portion of batch flow aperture 416 together with the other shutter plates S2, S3, S4, and first and second ends 420, 422 to overlap adjacent shutter plates S2, S4. The shutter plate S1 can comprise a first guide mesa 424 protruding from an upstream surface 426 of the shutter plate S1 and extending in a radial direction R, and a second mesa 428 protruding from a downstream surface 430 of the shutter plate S1 and also extending in a radial direction R. The shutter plate S1 can comprise guide slots 432 on either side of the first and second mesas 424, 428 that extend parallel to the first and second mesas 424, 428. The upstream surface 426 can comprise a first step 434 that extends parallel to the first mesa 424 and the guide slots 432 to a first slide surface 436. The downstream surface 430 can comprise a second step 438 that extends parallel to the second mesa 428 and the guide slots 432 to a second slide surface 440, the second slide surface 440 being on an opposite end 422 of the shutter plate S1 from the first slide surface 436.

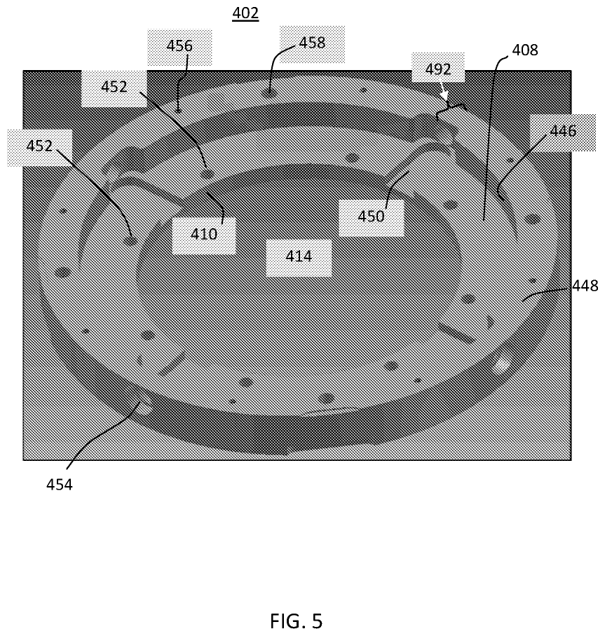

FIG. 5 is perspective view of the base ring of the bow control device of FIG. 4A according to exemplary embodiments of the disclosure. The base ring 402 comprises the inner surface 410, the radial cavity 408, an axial wall 446 at the back of the radial cavity 408, and a downstream surface 448 at the top of the axial wall 446. The floor of the radial cavity comprises base radial grooves 450 that extend in the radial direction and guide pin holes 452 on either side of the base radial grooves 450. The axial wall 446 comprises through holes 454 at the base radial grooves 450.

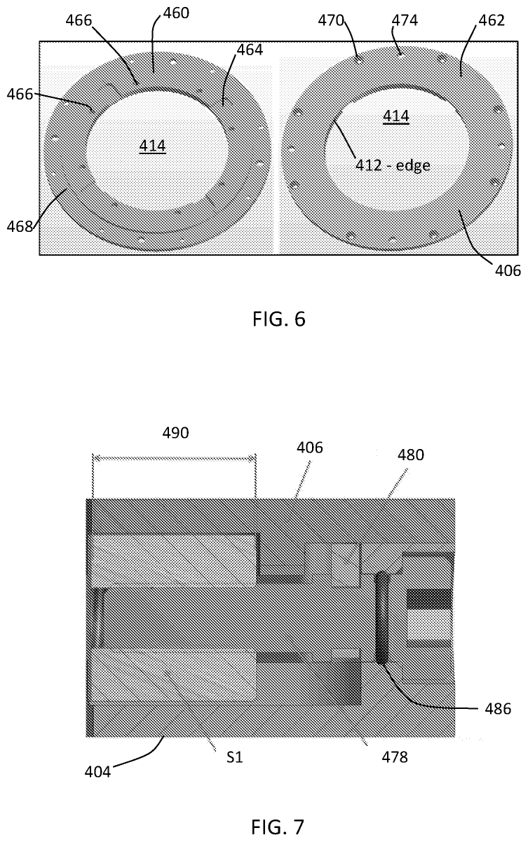

FIG. 6 shows perspective views of upstream surface 460 and downstream surface 462 of the cover ring plate 406 of the bow control device 204 of FIG. 4A according to exemplary embodiments of the disclosure. The upstream surface 460 can comprise cover radial grooves 464 that extend in the radial direction and guide pin holes 466 on either side of the cover radial grooves 464. The upstream surface 460 comprises a contact surface 468 to mate with the downstream surface 448 of the base ring 402 and a cavity surface disposed radially inward of the contact surface 468 to cover the radial cavity 408 of the base ring 402. The cover ring plate 406 comprises through holes 470 for joining the cover ring plate 406 to the base ring 402 with fasteners 472 such as threaded bolts or screws, and boss through holes 474 for bosses 214 to join the extended range hardware to the tail ring 202. FIG. 7 is a cross section detail view at VII of the bow control device 204 of FIG. 4C according to exemplary embodiments of the disclosure.

Examples of extrudate bow corrector devices for correcting bow in a stream of extruded material are provided in U.S. Pat. No. 6,663,378, issued Dec. 16, 2003, U.S. patent application having Ser. No. 10/370,840 and Publication No. 2004/0164464, published Aug. 26, 2004, and U.S. patent application having Ser. No. 14/061,129 and Publication No. 2015/0108680, filed on Oct. 23, 2013, all of which are hereby incorporated by reference in their entireties as if fully set forth herein.

As illustrated in the bow control device 204 of FIGS. 4A, 4B, 4C, 4D, 5, 6, and 7, the shutter plate S1 can be slideably disposed in the radial cavity 408 having the first mesa 424 disposed in the base radial groove 450 and the second mesa 428 disposed in the corresponding cover radial groove 464. Guide pins 476 disposed in guide pin holes 452 of the base ring 402 and corresponding guide pin holes 466 of the cover ring plate, can extend through guide slots 432 of the shutter plate S1 such that shutter plate S1 can move radially in the radial cavity 408 with the guide slots 432 moving radially on the guide pins 476. The guide pins 476 can provide end-stops for the radial movement of the shutter plates S1, S2, S3, S4.

Threaded bolt 478 retained in axial wall 446 of base ring 402 by retaining clip 480 can move the shutter plate S1 radially into and out of the batch flow opening 414. The axial wall 446 can be thinner 492 at the through holes 454 to provide space for a more robust retaining clip 480. The more robust the retaining clip 480, the higher the forces that can be applied to the threaded bolt 478 that can result when making adjustments under high batch extrusion pressures. The shutter plate S1 can have threaded bolt hole 482 threaded on threaded bolt 478 such that shutter plate S1 moves radially when threaded bolt 478 is rotated. Threaded bolt 478 can be rotated by threaded bolt head 484 and O-ring 486 can provide a seal at through hole 454. Precision threading can provide precision positioning and allow higher force application. While disclosed as a threaded bolt and coupling to move shutter plate S1 radially, exemplary embodiments of the disclosure are not limited thereto, for example, a pneumatic or hydraulic piston coupled to shutter plate S1 may move the shutter plate S1 radially in guide grooves 450, 464 on guide pins 476. This can include, for example, a stepper motor or other electrical or mechanical driven devices.

As shutter plate S1 moves radially in guide grooves 450, 464 on guide pins 476, the first slide surface 436 overlaps a second slide surface 440 of the adjacent shutter plate S4 at the first end 420 of shutter plate S1 and the second slide surface 440 overlaps a first slide surface 436 of the adjacent shutter plate S2 at the other end 422 of the shutter plate S1. As illustrated in FIG. 4B, the shutter plates S1, S2, S3, S4 are fully extended radially into batch flow opening 414 forming batch flow aperture 416 at a center thereof. FIG. 4C shows shutter plates S1, S2, S4 fully retracted into radial cavity 408 such that first and second slide surfaces 436, 440 still overlap on adjacent shutter plates S1, S2 and S1, S4, but a first gap 486 has opened between the first axial step 434 of shutter plate S1 and second axial step 438 of shutter plate S4 and a second gap 488 has opened between the second axial step 438 of shutter plate S1 and first axial step 434 of shutter plate S1.

The shutter plates S1, S2, S3, S4 are described as movably mounted to the downstream side of the base ring 402, but exemplary embodiments are not limited thereto and the shutter plates S1, S2, S3, S4 may be mounted to the upstream side of the base ring 402. The shutter plates S1, S2, S3, S4 block extrudate flow except extrudate flow through aperture 416. When the shutter plates S1, S2, S3, S4 move in a radial direction, the aperture 416 changes size and/or location radially within batch flow opening 414 based on the movement of the shutter plates S1, S2, S3, S4. For example, when shutter S1 extends into the batch flow opening 414 from the radial cavity 408, aperture 416 decreases and is off center from batch flow opening 414. Changing the position of shutter plates S1, S2, S3, S4, not only affects the direction, but also the magnitude of bowing that can be corrected. The position of the shutter plates S1, S2, S3, S4 can be selected to achieve desired magnitude of bow correction, in any direction. For example, aperture 416 in bow control device adjusted to an intermediate position to the right and down from center corrects down and right bow for a predetermined degree of bow correction.

The plasticized batch flows through the bow control device 204 prior to entering and passing through the die of the die assembly 210. As the plastic batch flows through the die of the die assembly 210, it does so having a unique flow velocity superimposed thereon as determined by the peripheral edge 418 of the aperture 416 of the bow control device 204, and the position of the aperture 416. This flow velocity gradient counteracts preferential flow in the die of the die assembly 210, resulting in equal batch flow throughout the die. Therefore, as the honeycomb extrudate emerges from the die of the die assembly 210 it is absent of any bow in any direction. The bow control device 204 can be directly adjacent the die 210 or other intervening extrusion hardware devices may be present, such as edge flow control device 206. For example, in FIG. 2, edge flow control device (flow plate) 206 is illustrated disposed between the bow control device 204 and the die 210.

The aperture 416 can move anywhere within the constraints of the base ring 402 by adjustment of respective radial adjustment members 478 (threaded bolts) on the shutter plates S1, S2, S3, S4. The aperture 416 in an upper left position counters upper left bow in the extrudate. The aperture 416 in an upper right position counters upper right bow in the extrudate. The aperture 416 in a right position and the aperture 416 in a bottom position counter right bow and downward bow, respectively, in the extrudate. For example, the aperture 416 can move to these described positions by turning bolts 478. When moved over a portion of the range of motion 490 of the shutter plates S1, S2, S3, S4, the size and shape of the aperture 416 can remain unchanged.

The aperture 416 can be positioned to provide the most effective flow correction as required to provide for a straight extrudate, to counter the issues that prevent it from being straight naturally, with minimal impact on cross sectional shape of the extrudate. For example, when the extrudate cross sectional shape is an ellipse, the aperture 416 can be an ellipse, or when the extrudate cross sectional shape is a circle, the aperture 416 can be a circle.

The bow control device 204 as described herein has flat and parallel contact surfaces between the base ring 402 and cover ring plate 406, for example, no grooves for O-rings are present on the downstream surface 448 on top of the axial wall 446 of the base ring 402. This arrangement provides a more robust base ring 402 and simpler machining than one having stepped edges and O-ring grooves. Similarly, the cover ring plate 406 can have no stepped edges and O-ring grooves for a robust structure.

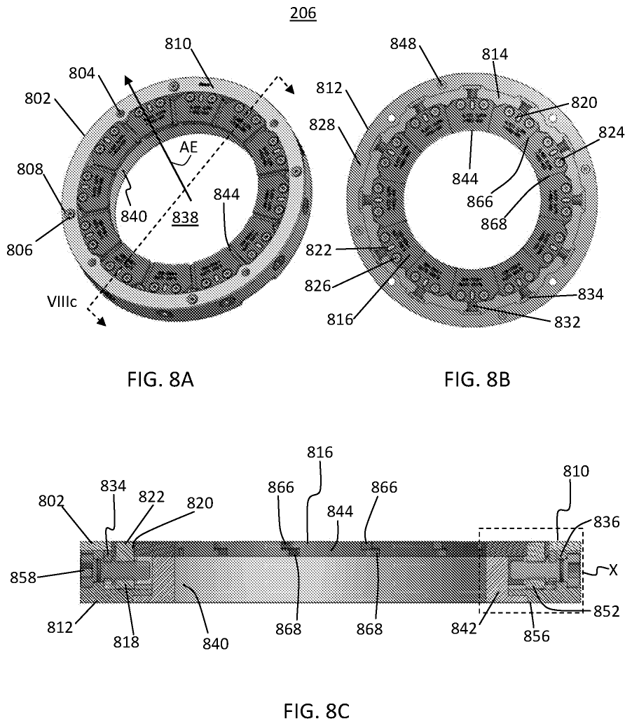

The downstream surface 468 of the cover ring plate 406 can be the downstream surface of the bow control device 204. The downstream surface 468 of the bow control device 204 can be disposed on an upstream surface of the edge flow control device 206. FIG. 8A is a perspective view of an edge flow control device 206 of the honeycomb extrusion apparatus 200 in FIG. 2 according to exemplary embodiments of the disclosure. FIG. 8B is a perspective view of the edge flow control device 206 of FIG. 8A with an edge cover plate 802 removed and FIG. 8C is a cross section view of the edge flow control device 206 of FIG. 8A at VIIIc according to exemplary embodiments of the disclosure.

Edge flow control device 206 comprises an edge cover plate 802. Edge cover plate 802 comprises boss holes 804 for bosses 214, fastener holes 806 for fasteners 808, and downstream surface 810. The edge flow control device 206 comprises support ring 812 having a rider block cavity 814 within the support ring 812. An edge plate 816 is disposed on a rider block 818 disposed in rider block cavity 814. The edge plate 816 comprises a center pin opening 820 to accept rider block pin 822 and fastener holes 824 to accept fasteners 826. The rider block pin 822 and fasteners 826 secure the edge plate 816 to the rider block 818. The support ring 812 comprises an outer wall 828 radially outward from the rider block cavity 814 having through holes 830. Adjustment bolts 832 disposed in through holes 830 and retained by retaining clips 834 are threaded into threaded holes 836 of rider blocks 818 such that when adjustment bolt 832 rotates rider block 818 and edge plate 816 secured thereto move radially.

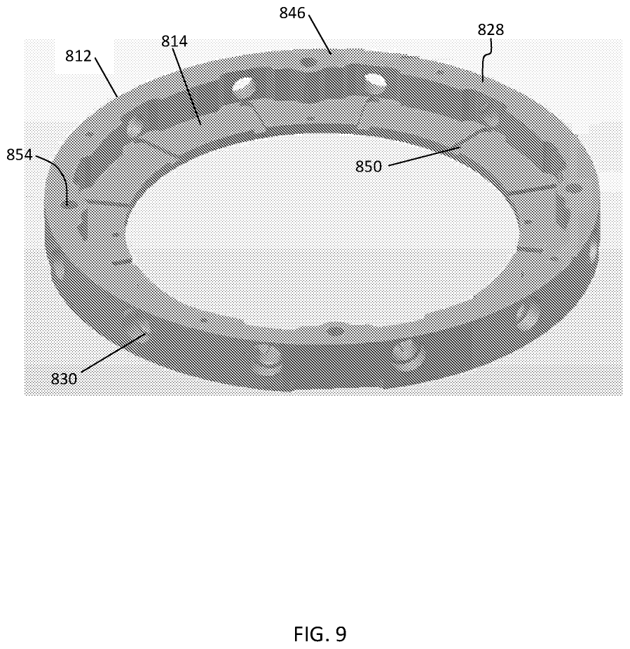

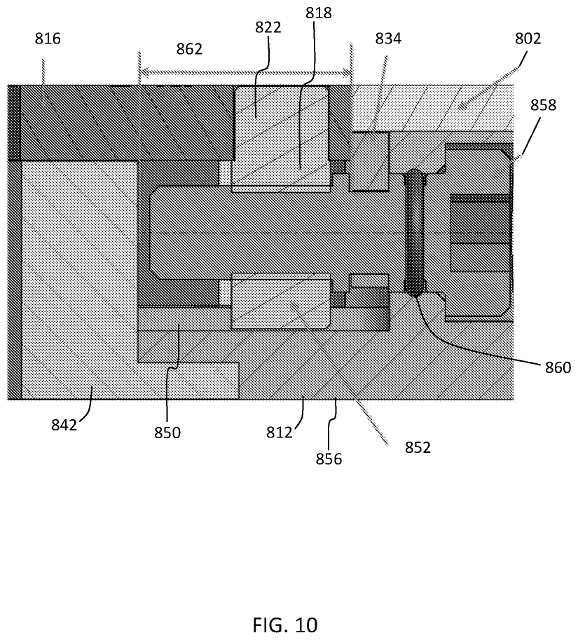

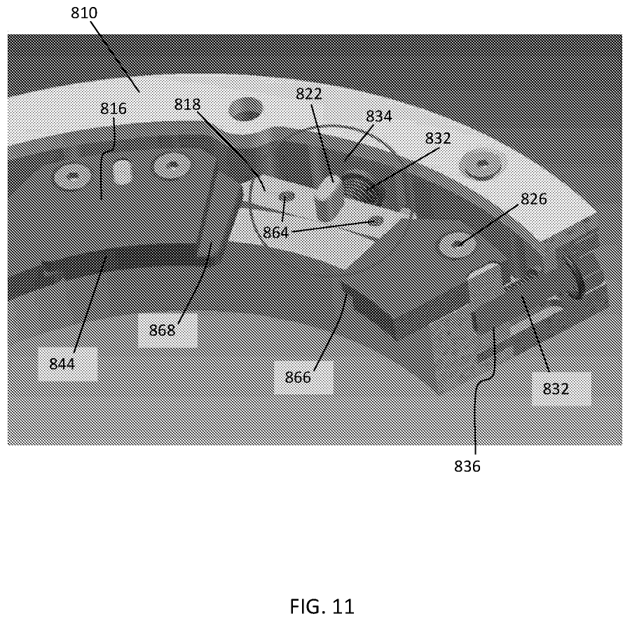

FIG. 9 is perspective view of the support ring 812 of the edge flow control device 206 of FIG. 8A according to exemplary embodiments of the disclosure. FIG. 10 is a cross section detail view of the edge flow control device 206 of FIG. 8C at X according to exemplary embodiments of the disclosure. FIG. 11 is a partial perspective and cross section detail view of the edge flow control device 206 of FIG. 8A with an edge plate 816 removed according to exemplary embodiments of the disclosure.

The edge flow control device 206 comprises a batch flow opening 838 formed by an inner surface 840 of the support ring 812. The inner surface 840 may be an inner surface of a support ring liner 842 and the support ring liner 842 may be integral with the support ring 812. The edge plate 816 comprises an inner surface 844 that protrudes into the batch flow opening 838 when the edge plate 816 moves radially inward to adjust differences in skin-body flow rates at multiple locations around the die 210. The edge flow control device 206 is composed of a plurality of edge plates 816, for example, six to twelve, movably mounted on support ring 812.

The edge cover plate 802 can be disposed on a downstream surface 846 on top of the outer wall 828 of the support ring 812 and attached by fasteners 808 disposed in fastener holes 848 in the outer wall 828. The floor of the rider block cavity 814 can have radial grooves 850 corresponding to through holes 830 to accommodate protrusions 852 on the rider blocks 818 so that as a rider block 818 is moved radially the protrusion 852 can slidably move in radial groove 850. The support ring 812 further comprises boss holes 854 for bosses 214, and upstream surface 856. Adjustment bolt 832 can be rotated by adjustment bolt head 858 and O-ring 860 can provide a seal at through hole 830 to move edge plate 816 radially over range of motion 862. Edge plate 816 attached to rider block 818 by fasteners 826 extending into rider block fastener holes 864 and rider block pin 822 extending into opening 820 in of the edge plate 816 provides a robust attachment between the rider block 818 and the edge plate 816. Further, the axial wall 828 of the support ring 812 can be thinner at the through holes 830 than away from the through holes 830 providing a space for more robust retaining clips 834. As described above with regard to the shutter plates S1, S2, S3, S4, the edge plates 816 can have over lapping upstream surfaces 866 and downstream surfaces 868 so that an upstream surface 866 of an edge plate 816 overlaps a downstream surface 868 of an adjacent edge plate 816 on one side and a downstream surface 868 of the edge plate 816 overlaps an upstream surface 866 of an adjacent edge plate 816 on the other side.

The edge flow control device 206 as described herein has no complicated transitions forms and shapes, for example, no grooves for O-rings are present on the downstream surface 846 on top of the outer wall 828 of the support ring 812, instead, contacting surfaces are flat and parallel. The adjustment mechanism for the edge plate 816, i.e., the adjustment bolt 832 and the rider block 818, have clearly defined end stop positions extended into the batch flow opening 838 and retracted out of the batch flow opening 838 in the rider block cavity 814. Furthermore, changes from one contour to another contour can be easily managed by changing the contour specific support ring 812 and edge plates 816. The edge plates 816 attached and bolted to the rider blocks 818 can move radially by turning the adjustment bolt 832. These edge plates 816 impact the batch flow. The geometry of the rider block 818 is simple with no need for grooves, edges and rounding. This simplifies manufacturing. Additionally, the thickness of the rider block 818 and the edge plates 816 are great enough to take on high loads and forces. An oval shaped pin 822 FIG. 11 on the rider block 818 provides stability and alignment.

Improvement to the adjustment bolt 832 and the support ring 812 allow the use of a thicker retainer clip 834. This protects the system against over tightening and external forces. Edge cover plate 802 acts as a robust hold down ring comprising a single piece. The edge cover plate 802 provides sealing, radial end stop for the rider block 818, and hold down of the retainer clip 834.

The edge flow control device 206 can be positioned upstream or adjacent inlet face of the die 210, as shown in FIG. 2, and act to regulate the batch flow into the peripheral feed holes of the die 210. Edge plates 816 can be adjusted to control flow of the batch in one or more of peripheral feed holes, and at one or more locations around die 210. Consequently, batch flowing into a skin forming device 212 is also further controlled by edge flow control device 206. The skin forming device 212 and the edge flow control device 206 act in combination to control the batch in the skin region of die 210.

Skin forming device 212 can include a variable shim thickness mask (varigap) hardware. The varigap can be manipulated to control an extrusion process. The varigap can be manipulated to control a peripheral gap to impact skin velocity as described in U.S. Patent Application 2013/0300016, the entire contents of which are incorporated by reference as if fully set forth herein. In brief, the varigap is described with respect to the extrudate flow in axial direction “AE” through die matrix slots to form the matrix webs of the extrudate and peripheral slots to form the skin of the extrudate. When extrudate from peripheral slots encounter a mask ring in a skin forming gap, the skin is formed integral with the extrudate matrix. The varigap hardware is configured to adjust the skin forming gap by movement of a mask ring. When the varigap hardware increases the skin forming gap the skin velocity exiting the mask ring is reduced. Conversely, decreasing the skin forming gap increases skin velocity exiting the mask ring.

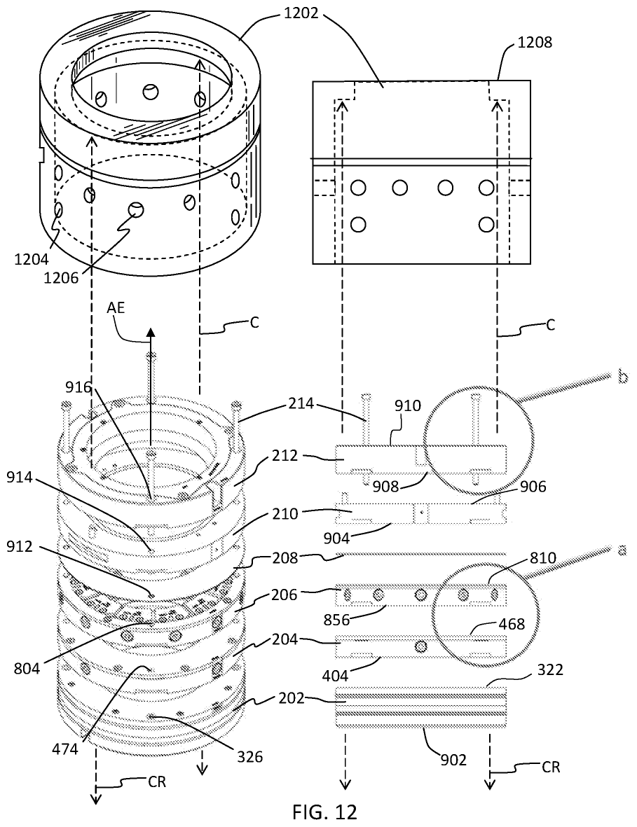

FIG. 12 shows a perspective view and a side view of an extruder front end assembly 200 and a cartridge 1202 that houses and supports hardware devices to control extrusion processes at an extruder front end according to exemplary embodiments of the disclosure. The extruder front end and the cartridge 1202 may be considered part of an extruder. As described above, the tail ring 202 has a flat downstream surface 322 perpendicular to the extrusion direction AE and parallel to an upstream surface 902. The bow control device 204 having flat parallel upstream and downstream surfaces 492, 406 perpendicular to the extrusion direction AE is disposed with the upstream surface 492 on the downstream surface 322 of the tail ring 202. Edge flow control device 206 comprising flat and parallel downstream and upstream surfaces 810, 856 perpendicular to extrusion direction AE is disposed on downstream surface 468 of the bow control device 204 with the upstream surface 856 on the downstream surface 468 of the bow control device 204. The flat and parallel surfaces 322, 404, 468, 856 allow high contact forces to provide sealing between the devices 202, 204, 206, preferably without stepped surfaces, without O-rings, without O-ring grooves, and the like, indicated at “a”. However, sealing rings may be used, such as a flat gasket, O-ring, and the like. The flat and parallel areas of contact also provide large areas of sealing surface. As indicated at “b”, the high contact forces can be provided by bosses 214 in boss holes 804, 474, 326, 912, and 914 and anchored in t-shaped inserts 312 in the tail ring 202, in addition to high batch pressure during the extrusion process.

As illustrated in FIG. 12, the edge control device shim 208, the die assembly 210, and the skin forming device 212 may be further disposed on the downstream surface 810 of the edge flow control device 206. The edge control device shim 208 comprises flat and parallel upstream and downstream surfaces perpendicular to the axial extrusion direction AE. The die assembly 210 comprises flat and parallel upstream and downstream surfaces 904, 906 perpendicular to the axial extrusion direction AE. The edge control device shim 208 can be disposed between the downstream surface 810 of the edge flow control device 206 and the upstream surface 904 of the die assembly 210. The skin forming device 212 comprises flat and parallel upstream and downstream surfaces 908, 910 perpendicular to the axial extrusion direction AE, and the upstream surface 908 can be disposed on the downstream surface 906 of the die assembly 210. The downstream surface 910 of the skin forming device 212 comprises the exit of the extruder assembly where the extrudate exits the extruder. The bosses 214 can further be disposed in boss holes 912, 914, 916 in the edge control device shim 208, die assembly 210, and skin forming device 212 and anchored in the t-shaped inserts 312 in the tail ring 202.

The cartridge 1202 may have through holes 1204 to adjust externally the bow control device 204 shutter plates S1, S2, S3, S4 and through holes 1206 to adjust externally the edge flow control 206 edge plates 816. Again, a suitable servo-motor, wrench, pneumatic, or hydraulic unit may be used to control the movement of bolts (adjustors) 478, 832, and obtain the desired settings for bow control device 204 and edge flow control device 206, respectively. The extruder assembly 202, 204, 206, 208, 210, 212 can be axially inserted into cartridge 1202 as indicated by dashed arrows C and axially removed from cartridge 1202 in an opposite direction CR. Bosses (not shown) may extend through the front end 1208 of the cartridge 1202 to secure the extruder assembly 202, 204, 206, 208, 210, 212 in the cartridge 1202.

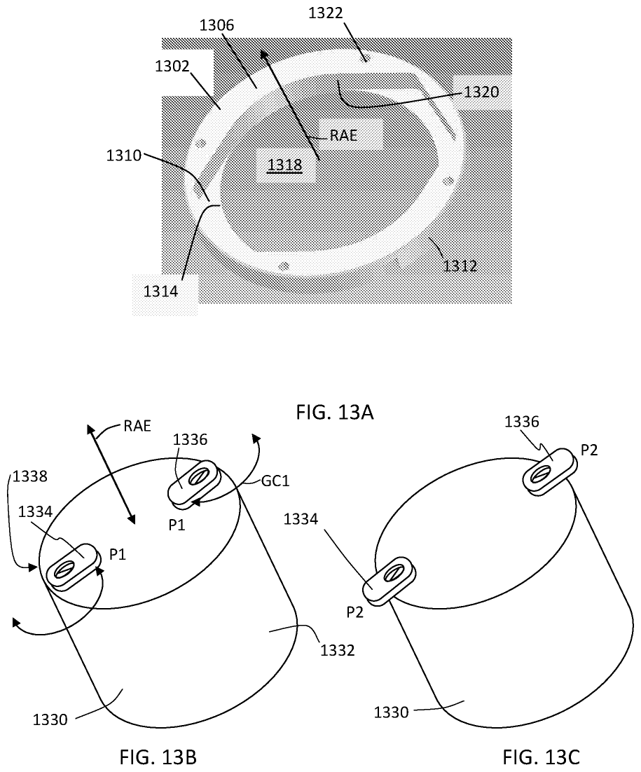

To facilitate removal of the extruder assembly 202, 204, 206, 208, 210, 212 axially from the cartridge 1202 in direction CR, a kit device for gripping the extruder assembly 202, 204, 206, 208, 210, 212 is provided. FIG. 13A is a perspective view of a change-over ring 1302 configured to attach to the tail ring device 202 of the honeycomb extrusion apparatus 200 according to exemplary embodiments of the disclosure. The tail ring device 1302 comprises a downstream surface 1306 to dispose on upstream surface 902 of the tail ring 202, an attachment pocket 1310 formed by a narrow portion of the change-over ring axial wall 1312 and an upstream radial protrusion 1314 that creates an overhang of the attachment pocket 1310. The tail ring device 1302 comprises a socket opening 1318 defined by an axial inner wall 1320 and an inner edge of radial protrusion 1314. When the change-over ring 1302 is disposed on the tail ring 202, the axial direction of the change-over ring 1302 indicated by arrow RAE corresponds to the extrusion direction AE. The upstream radial protrusion 1314 that creates an overhang of the attachment pocket 1310 can be substantially perpendicular to the axial direction RAE. Bosses (not shown) can be attached to upstream t-shaped inserts 312 disposed in grooves 314 of upstream part 308 of tail ring 202 through boss holes 1322 and 326 to attach the change-over ring 1302 to the tail ring 202.

FIG. 13B is a perspective view of a grip tool 1330 configured to slide axially into the socket opening 1318 of the change-over ring 1302 attached to the tail ring device 202 and FIG. 13C is a perspective view of the grip tool 1330 configured to engage the change-over ring 1302 attached to the tail ring device 202 according to exemplary embodiments of the disclosure. The grip tool 1330 comprises a grip body 1332 configured to slidably fit one end in socket opening 1318 of change-over ring 1302, and grip cogs 1334, 1336 to protrude into attachment pocket 1310 of change-over ring 1302. Grip cogs 1334 and 1336 are configured to retract to a first position P1 as indicated in FIG. 13B so that the grip tool 1330 attachment end 1338 can be inserted into socket opening 1318 and to extend to a second position P2 as indicated in FIG. 13C to protrude into attachment pocket 1310 of change-over ring 1302 to engage radial protrusion 1314 with an axial force when an axial force is applied to the grip body 1332. The grip cogs 1334, 1336 may pivot from the first position P1 to the second position P2 in a pivot direction GC1 or the grip cogs 1334, 1336 may slide from the first position P1 to the second position P2. The kit device comprises the change-over ring 1302 and the grip tool 1330.

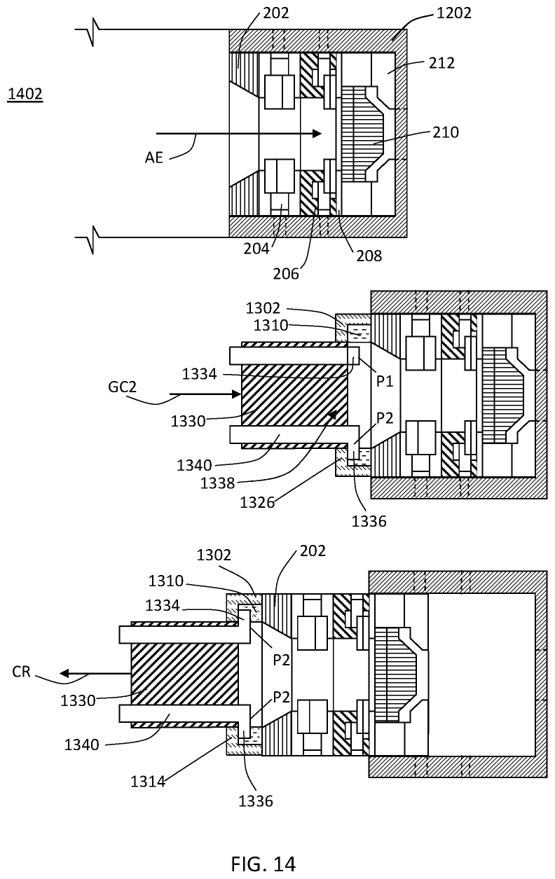

FIG. 14 is a schematic diagram illustrating a method of removing the honeycomb extrusion apparatus 200 in FIG. 2 from an extrusion cartridge 1202 according to exemplary embodiments of the disclosure. The extrusion assembly 200 comprising the tail ring 202, bow control device 204, and edge flow control device 206 can be disposed in the extrusion cartridge 1202 to extrude batch mixture through the die assembly 210 to form honeycomb extrudate. To remove the extrusion assembly 200, the change-over ring 1302 downstream surface 1306 can be attached to the upstream surface 918 of the tail ring 202, the grip tool 1330 attachment end 1338 having grip cogs 1334, 1336 retracted can be axially inserted in direction GC2 in socket opening 1318 and the grip cogs 1334, 1336 can be extended into attachment pocket 1310. A cog operator 1340, for example, a handle, cable, shaft, or rod, can move the grip cogs 1334, 1336 from the first position P1 to the second position P2. The grip cogs 1334, 1336 in the second position P2 engage the change-over ring overhang of the radial protrusion 1314 and apply an axial force in direction CR when the grip tool 1330 is moved axially in direction CR to withdraw the extrusion assembly 200 from the extrusion cartridge 1202. The grip cogs 1334, 1336 can then be retracted and the grip tool 1330 removed from the extrusion assembly 200.

Inserting the extrusion assembly 200 into the extrusion cartridge 1202 can be performed in the same manner as withdrawing the extrusion assembly 200 from the extrusion cartridge 1202, but in the opposite order. According to exemplary embodiments a first extrusion assembly 200 having a first contour specific geometry can be removed from the extrusion cartridge 1202 and a second extrusion assembly 200 having a second contour specific geometry different from the first contour specific geometry can be inserted in to the extrusion cartridge 1202.

While terms, top, side, vertical, and horizontal are used, the disclosure is not so limited to these exemplary embodiments. Instead, spatially relative terms, such as “top”, “bottom”, “horizontal”, “vertical”, “side”, “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly. Thus, the exemplary term “side” can become “top” and vice versa when the bow deflection device 712 in FIG. 7 is rotated 90 degrees counter clockwise.

In operation, the batch flowing towards the die 210 in axial direction AE first encounters the tail ring 202 to funnel the batch to an opening 414 of the bow control device 204, the bow control device 204 can be positioned to correct any degree of bow in the batch. Next, the exterior of the batch encounters the edge flow control device 206 which acts to control the flow of the batch into the peripheral feed holes of the die of the die assembly 210. At the exit of the edge flow control device 206 the batch enters the die 210, where it is extruded. The peripheral area of the batch encounters the skin-forming assembly 212 which controls both the amount of batch coming out of the peripheral discharge slots, and the skin thickness. Control of the various components of the extrusion apparatus can be made externally thereto. The resulting extruded structure, exiting the outlet end of the die, is a honeycomb 100 having an integral outer skin 106 formed thereon.

The controls architecture for the extruding process can respond to a quality metric to adjust critical system parameters like extrusion pressure, skin speed, and bow correction. According to these exemplary embodiments adjustments can be made to these parameters to maintain good skin quality, maintain good shape quality or reduce length of upsets thereby reducing waste and cost in the process.

Advantages of the extrusion system provided in accordance with the present disclosure allow manufacturing of extrude-to-shape honeycomb bodies of diameter greater than 5.7 inches (14.5 cm), for example up to 7 inch (17.8 cm) diameter, or even up to 8 inch diameter (20.3 cm) diameter extrude-to-shape honeycomb bodies. Previous apparatus according to the prior art could not achieve greater than 5.7 inch (14.5 cm) diameter extrude-to-shape honeycomb bodies because the extrusion pressure needed caused binding of control mechanisms and leakage of batch at the control mechanisms. The flatness of the faces of the individual components in combination with the higher contact pressure eliminates batch leakages. The improvements described according to the present disclosure facilitate easier adjustment to the bow control device shutters and edge control device plates even at pressures needed achieve greater than 5.7 inch (14.5 cm) diameter extrude-to-shape honeycomb bodies. Further, installation and usage is facilitated through the clear labeling. Exemplary embodiments of the disclosure lead to low machining lead time, low machining effort, and low machining cost advantages. Additionally, exemplary embodiments of the disclosure provide handling advantages in assembly and disassembly for the operator. This leads to a reduction in changeover time between setup changes and product changes. Advantages of the extrusion system as disclosed herein include reduced effort for preparation and post-processing, as well as, less cleaning according to exemplary embodiments.

Reference throughout this specification to exemplary embodiments and similar language throughout this specification may, but do not necessarily, refer to the same embodiment. Furthermore, the described features, structures, or characteristics of the subject matter described herein with reference to an exemplary embodiment may be combined in any suitable manner in one or more exemplary embodiments.

It will be apparent to those skilled in the art that various modifications and variations can be made in the present disclosure without departing from the spirit or scope of the disclosure. Thus, it is intended that the appended claims cover the modifications and variations of this disclosure provided they come within the scope of the appended claims and their equivalents.

1. An extrusion apparatus to extrude plasticized ceramic precursor batch through a die to form a honeycomb body extrudate, the apparatus comprising:
a tail ring device comprising a tapered inner opening configured to funnel the batch downstream from upstream extrusion hardware;
a bow control device disposed on the tail ring device, and the bow control device comprising an inner batch flow opening and an aperture defined by adjustable shutter plates, the bow control device configured to receive the batch from the tail ring and configured to control a bow of the honeycomb body extrudate; and
an edge flow control device disposed on the bow control device, and the edge flow control device comprising:
a batch flow opening configured to receive the batch from the bow control device, and
edge plates configured to protrude into the batch to control an edge flow of the batch flowing to a periphery of the die.

2. The apparatus of claim 1, wherein the tail ring device further comprises:
an upstream ring, comprising:
an upstream surface, a downstream surface parallel to the upstream surface, and an upstream portion of the inner surface extending from a first area of the tapered inner opening at the upstream surface to a second area of the opening smaller than the first area at the downstream surface; and
a downstream ring, comprising:
an upstream surface parallel to the surfaces of the upstream ring, a downstream surface parallel to the upstream surface, and a downstream portion of the inner surface extending from a first area of the tapered inner opening at the upstream surface to a second area of the opening smaller than the first area at the downstream surface.

3. The apparatus of claim 2, wherein
the downstream surface of the upstream ring comprises:
a groove and an axial hole, the axial hole extending through the upstream ring from the groove to the upstream surface; and
a t-shaped insert disposed in the groove having a cylinder extending through the axial hole, and
the upstream surface of the downstream ring comprises:
a groove and an axial hole, the axial hole extending through the downstream ring from the groove to the downstream surface; and
a t-shaped insert disposed in the groove having a cylinder extending through the axial hole, and
the upstream surface of the downstream ring is disposed on the downstream surface of the upstream ring.

4. The apparatus of claim 3, further comprising a boss extending through the edge flow control device and the bow control device into the cylinder extending through the axial hole of the downstream ring of the tail ring device to attach the edge flow control device and the bow control device to the tail ring device.

5. The apparatus of claim 3, further comprising:
a skin forming device disposed downstream of a die assembly comprising the die; and a boss extending through the skin forming device, the die assembly, the edge flow control device and the bow control device into the internally threaded cylinder extending through the axial hole of the downstream ring of the tail ring device to attach the skin forming device, the die assembly, the edge flow control device, and the bow control device to the tail ring device.

6. The apparatus of claim 1, wherein
the tail ring device comprises upstream and downstream flat and parallel surfaces,
the bow control device comprises upstream and downstream flat and parallel surfaces, the bow control device upstream surface disposed on the tail ring device downstream surface, and
the edge flow control device comprises upstream and downstream flat and parallel surfaces, the edge flow control device upstream surface disposed on the bow control device downstream surface.

7. The apparatus of claim 1, wherein the shutter plates of the bow control device are all substantially identical and interchangeable.

8. The apparatus of claim 1, wherein an inner surface of the tail ring device defining the inner opening comprises no pockets or protrusions to disrupt batch flow

9. The apparatus of claim 1, wherein the tail ring device comprises an ultra high molecular weight polymer.

10. A method of assembling an apparatus to extrude a honeycomb body in an axial direction, the method comprises:
attaching a die to an edge control device, a bow control device and a tail ring device to form a first assembly;
attaching a change-over ring to the tail ring device, the tail ring device comprising a tapered inner opening configured to funnel batch downstream from upstream extrusion hardware, the change-over ring comprising a pocket defined by a radial protrusion configured to engage a grip tool;
engaging the change-over ring with a grip tool;
sliding the grip tool and tail ring device attached to the first assembly into a cartridge at a front end of an extruder;
disengaging the grip tool from the change-over ring; and
removing the change-over ring from the tail ring device.

11. The method of claim 10, wherein
the tail ring device further comprises an upstream ring, comprising an upstream surface and a downstream surface parallel to the upstream surface, and a downstream ring, comprising an upstream surface parallel to the surfaces of the upstream ring and a downstream surface parallel to the upstream surface, and
wherein attaching the die to the edge control device, the bow control device and the tail ring device comprises inserting a boss through boss holes in the edge control device, the bow control device, and the downstream ring of the tail ring device and securing the boss in an insert disposed in the upstream surface of the downstream ring.

12. The method of claim 10, wherein
the tail ring device further comprises an upstream ring, comprising an upstream surface and a downstream surface parallel to the upstream surface, and a downstream ring, comprising an upstream surface parallel to the surfaces of the upstream ring and a downstream surface parallel to the upstream surface, and
wherein attaching the change-over ring to the tail ring device comprises inserting a boss through boss holes in the change-over ring and the upstream ring of the tail ring device and securing the boss in an insert disposed in the downstream surface of the upstream ring.

13. The method of claim 10, wherein engaging the change-over ring with the grip tool comprises axially inserting an end portion of the grip tool into a socket opening of the change-over ring defined by an axial wall and a radial protrusion over a pocket, and extending a retractable grip cog disposed on the end portion into the pocket.

14. The method of claim 10, further comprising removing a second assembly from the cartridge before attaching the change-over ring to the tail ring device, wherein the second assembly comprises a contour specific geometry different from the first assembly.

15. The method of claim 10, wherein an inner surface of the tail ring device defining the inner opening comprises no pockets or protrusions to disrupt batch flow.

16. A method of manufacturing a honeycomb extrudate, comprising:
providing a pressure to a plasticized batch upstream of a tail ring device;
funneling the batch through an opening defined by a tapered inner diameter of the tail ring device, wherein the funneling comprises no dead zones for batch flow along the tapered inner diameter;
flowing the batch through an aperture of a bow control device downstream of the tail ring device;
controlling a bow of a honeycomb extrudate comprising adjusting the aperture;
flowing the batch through an opening of an edge flow control device comprising an edge plate downstream of the bow control device;
controlling a peripheral feed of the batch upstream of a honeycomb extrusion die comprising adjusting an edge plate position; and
extruding the batch through the die to form the honeycomb extrudate.

17. The method of claim 16, further comprising:
drying the honeycomb extrudate;
cutting the honeycomb extrudate; and
firing the honeycomb extrudate to produce a porous ceramic honeycomb body.

18. The method of claim 16, wherein the controlling the bow comprises a measuring to identify a bow in the honeycomb body extrudate, and the adjusting the aperture comprises moving a shutter plate comprising guide slots disposed on guide pins to correct the identified bow in the honeycomb body extrudate.

19. The method of claim 16, wherein the controlling the peripheral feed of the batch upstream of the honeycomb extrusion die further comprises moving a rider block comprising a rider block pin disposed in an opening of the edge plate to adjust the edge plate position.
